(19) United States
(12) Patent Application Publication
(10) Pub. No.: US 2010/0149807 A1
(43) Pub. Date: Jun. 17, 2010

(54) Light source apparatus

(76) Inventors: Tung-Chou Hu, Hukou Township (TW); Wei-Cheng Lo, Hukou Township (TW); Cheng Wang, Hukou Township (TW)

Correspondence Address: MH2 TECHNOLOGY LAW GROUP, LLP, 1951 KIDWELL DRIVE, SUITE 550, TYSONS CORNER, VA, 22182, US

(21) Appl. No.: 12/591,688

(22) Filed: Nov. 30, 2009

(30) Foreign Application Priority Data
Dec. 15, 2008 (TW) 097148838

(51) Int. Cl. F21S 4/00

(52) U.S. Cl. 362/249.02; 362/249.01; 362/294

(57) ABSTRACT

A light source apparatus including a first heat transfer element, a second heat transfer element, at least one first light emitting element, and at least one second light emitting element is provided. The first heat transfer element has a first carrying surface and a first heat dissipation surface opposite to the first carrying surface. The second heat transfer element surrounds the first heat transfer element and has a second carrying surface and a second heat dissipation surface opposite to the second carrying surface. The thermal resistance of the first heat transfer element is smaller than the thermal resistance of the second heat transfer element. The first and the second light emitting elements are disposed over the first and the second carrying surfaces respectively. The luminance of the first light emitting element is easier to vary with a change of temperature than the luminance of the second light emitting element.

### CROSS-REFERENCE TO RELATED APPLICATION

This application claims the priority benefit of Taiwan application serial no. 97148838, filed on Dec. 15, 2008. The entirety of the above-mentioned patent application is hereby incorporated by reference herein and made a part of this specification.

### BACKGROUND

(1) Technical Field

The invention relates to a light source apparatus, and more particularly relates to a light source apparatus with stable luminance and color.

(2) Description of the Prior Art

In recent years, since the luminous efficiency of the light emitting diode (LED) increases continuously, a traditional light source is gradually replaced with the LED in many fields. The light emitting phenomenon of the LED does not belong to heating light emitting or discharge light emitting, but belongs to cold light source, so the LED may keep working for 100 thousand hours or greater. Besides, the LED further has advantages of quick response(about 10⁻⁹ seconds), small volume, low power consumption, low pollution, high reliability, and adapting for mass production, so the LED may be applied in a wide field.

With the development of optoelectronical technology, the LED may have a high power, so as to replace the traditional fluorescent lamp and be used to be the general indoor illumination or the general outdoor illumination. The general fluorescent lamp may have two different kind of light colors, one is white color with higher color temperature, and the other is amber color with lower color temperature. In the other hand, the LEDs may also be divided as white color LED emitting white light and amber color LED emitting amber light.

FIG. 1 shows a curve graph of the relationship between the relative outputting luminous flux and the temperature of the heat dissipation pad of the white color LED and the amber color LED. Please refer to FIG. 1, the heat dissipation pad may be the element disposed below the LED for conducting away the heat generated by the LED, and the temperature of the heat dissipation pad concerns with the temperature of the LED. As shown in FIG. 1, the amber color LED is easier to be influenced by temperature than the white color LED, that is, when the temperature of the amber color LED is rising according to the increase of the working time of the amber color LED, the light intensity of the amber color LED may decrease greater than the light intensity of the white color LED, and this may not satisfy users' requirement for the light intensity. Furthermore, when the white color LED and the amber color LED are disposed on the same heat dissipation pad, the ratio of the luminance of the amber color LED and the ratio of the luminance of the white color LED may become smaller according to the increase of the working time, and this causes a light color change of the white color LED and the amber color LED after light mixing. The .color of the mixed light may not satisfy the users' requirement.

Besides, since the light emitted from the LED has good directive property, the light source may be over-concentrate. When the LED is used for the indoor illumination or the outdoor illumination, the over-concentrate light source may cause glare and make people uncomfortable.

### SUMMARY

The invention provides a light source apparatus with stable luminance and color, and a light source with divergent light.

One embodiment of the invention provides a light source apparatus, the light source apparatus includes a first heat transfer element, a second heat transfer element, at least one first light emitting element, and at least one second light emitting element. The first heat transfer element has a first carrying surface and a first heat dissipation surface opposite to the first carrying surface. The second heat transfer element surrounds the first heat transfer element and has a second carrying surface and a second heat dissipation surface opposite to the second carrying surface. The thermal resistance of the first heat transfer element is smaller than the thermal resistance of the second heat transfer element. The first light emitting element is disposed over the first carrying surface, and the second light emitting element is disposed over the second carrying surface. The luminance of the first light emitting element is easier to vary with a change of temperature than the luminance of the second light emitting element.

In one embodiment of the invention, the first light emitting element and the second light emitting element are light emitting diodes. The emitted light color of the first light emitting element is different from the emitted light color of the second light emitting element. The first heat transfer element and the second heat transfer element are heat conductors. In one embodiment of the invention, the first heat transfer element is a vapor chamber or a heat pipe, and the second heat transfer element is a heat conductor. The light source apparatus further includes a plurality of second heat dissipation fins connecting to the second heat dissipation surface, and the light source apparatus further includes a plurality of first heat dissipation fins connecting to the first heat dissipation surface.

In one embodiment of the invention, the light source apparatus further includes a connecting strip, the first heat dissipation fins are connected to the first heat dissipation surface via the connecting strip, and the connecting strip is fixed to the second heat dissipation surface. There is a gap between the first heat transfer element and the second heat transfer element. The first heat dissipation fins and the second heat dissipation fins are disposed below the second heat dissipation surface and around the first heat dissipation surface. The light source apparatus further includes a fan disposed below the first heat dissipation surface, and the first heat dissipation fins and the second heat dissipation fins are disposed around the fan.

In one embodiment of the invention, the first heat transfer element protrudes from the second carrying surface and has a side reflection surface between the first carrying surface and the second carrying surface, and the side reflection surface is adapted for reflecting the light emitted from the second light emitting element. In one embodiment of the invention, the first carrying surface is disposed between the second carrying surface and the second heat dissipation surface, the second heat transfer element has an inner reflection surface between the first carrying surface and the second carrying surface, and the inner reflection surface is adapted for reflecting the light emitted from the first light emitting element. The first heat dissipation surface and the second heat dissipation surface face the same direction substantially.

In one embodiment of the invention, the light source apparatus further includes a first circuit board and a second circuit board. The first circuit board is disposed between the first carrying surface and the first light emitting element, and the first circuit board is electrically connected to the first light emitting element. The second circuit board is disposed between the second carrying surface and the second light emitting element, and the second circuit board is electrically connected to the second light emitting element and the first circuit board. The light source apparatus further includes a plurality of wires, a first electrical connector, and a second electrical connector. One end of each of the wires is electrically connected to the first light emitting element. The first electrical connector is electrically connected to another end of each of the wires. The second electrical connector is disposed on the second circuit board and is electrically connected to the second circuit board, and the first electrical connector and the second electrical connector are electrically connected by inosculating each other.

In one embodiment of the invention, the light source apparatus further includes a drive circuit and a lamp base. The drive circuit is electrically connected to the first light emitting element and the second light emitting element, and the lamp base is electrically connected to the drive circuit. In one embodiment of the invention, the light source apparatus further includes a lamp body and a light transmissive cover. The lamp body surrounds the first heat transfer element and the second heat transfer element, and the light transmissive cover is disposed on the lamp body and covers the first light emitting element and the second light emitting element.

In the light source apparatus of the embodiment of the invention, since the thermal resistance of the first heat transfer element is smaller than the thermal resistance of the second heat transfer element, the first heat transfer element may rapidly conduct the heat away from the first light emitting element having the luminance being easier to vary with the change of temperature, so as to prevent the luminance of the first light emitting element from varying with the increase of working time.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The present invention will now be specified with reference to its preferred embodiments illustrated in the drawings, in which

FIG. 1 shows a curve graph of the relationship between the relative outputting luminous flux and the temperature of the heat dissipation pad of the white color LED and the amber color LED;

FIG. 2A is a section view showing an embodiment of a light source apparatus according to the present invention;

FIG. 2B is the top view showing the first light emitting element, the second light emitting element, the first circuit board, and the second circuit board in FIG. 2A;

FIG. 3A is the bottom view showing the first heat dissipation fins, the second heat dissipation fins, and the connecting strip in FIG. 2A;

FIG. 3B is the explosion view showing the first heat dissipation fins, the second heat dissipation fins, and the connecting strip in FIG. 3A;

FIG. 3C is the I-I section view showing the first heat transfer element, the connecting strip, and the first heat dissipation fins in FIG. 3A;

FIG. 4 is a section view showing another embodiment of the light source apparatus according to the present invention.

### DETAILED DESCRIPTION

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

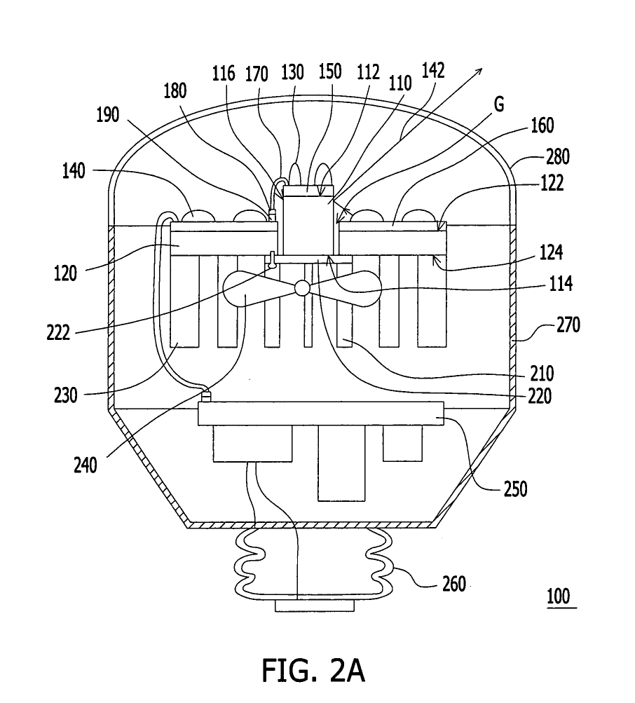

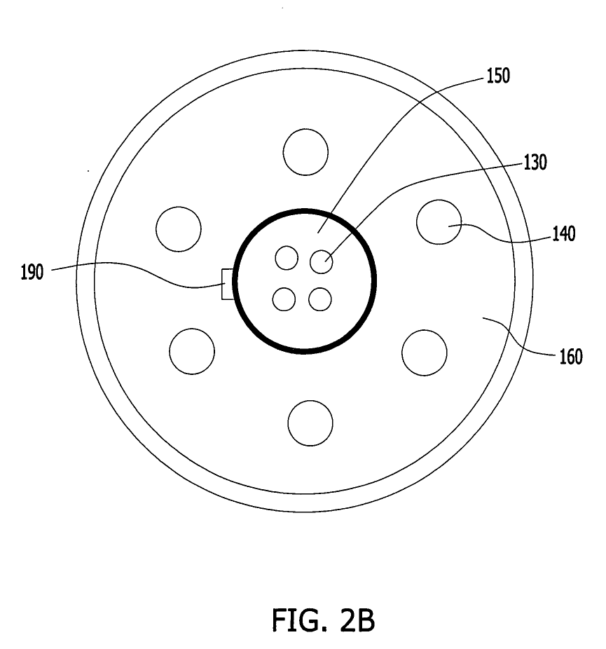

FIG. 2A is a section view showing an embodiment of a light source apparatus according to the present invention, and FIG. 2B is the top view showing the first light emitting element, the second light emitting element, the first circuit board, and the second circuit board in FIG. 2A. Please refer to FIG. 2A and FIG. 2B, according to the embodiment, a light source apparatus 100 includes a first heat transfer element 110, a second heat transfer element 120, a plurality of first light emitting elements 130, and a plurality of second light emitting elements 140. The first heat transfer element 110 has a first carrying surface 112 and a first heat dissipation surface 114 opposite to the first carrying surface 112. The second heat transfer element 120 surrounds the first heat transfer element 110 and has a second carrying surface 122 and a second heat dissipation surface 124 opposite to the second carrying surface 122, and the second heat dissipation surface 124 is around the first heat dissipation surface 114. In the embodiment, the first dissipation surface 114 and the second dissipation surface 124 face the same direction substantially. Besides, in the embodiment, the first carrying surface 112 and the second carrying surface 122 face the same direction substantially.

The first light emitting element 130 is disposed over the first carrying surface 112. In the embodiment, the light source apparatus 100 further includes a first circuit board 150 disposed between the first carrying surface 112 and the first light emitting element 130, and the first circuit board 150 is electrically connected to the first light emitting element 130. In other words, the first light emitting element 130 is disposed on the first carrying surface 112 via the first circuit board 150. The second light emitting element 140 is disposed over the second carrying surface 122. In the embodiment, the light source apparatus 100 further includes a second circuit board 160 disposed between the second carrying surface 122 and the second light emitting element 140, and the second circuit board 160 is electrically connected to the second light emitting element 140 and the first circuit board 150. In other words, the second light emitting element 140 is disposed on the second carrying surface 122 via the second circuit board 160.

In the embodiment of the invention, the second circuit board 160 is connected to the first circuit board 150 by a plurality of wires 170. Specifically, one end of each of the wires 170 is electrically connected to the first light emitting element 130, and another end of each of the wires 170 is electrically connected to a first electrical connector 180. A second electrical connector 190 is disposed on the second circuit board 160, and the second electrical connector 190 is electrically connected to the second circuit board 160. The first electrical connector 180 and the second electrical connector 190 are electrically connected by inosculating each other.

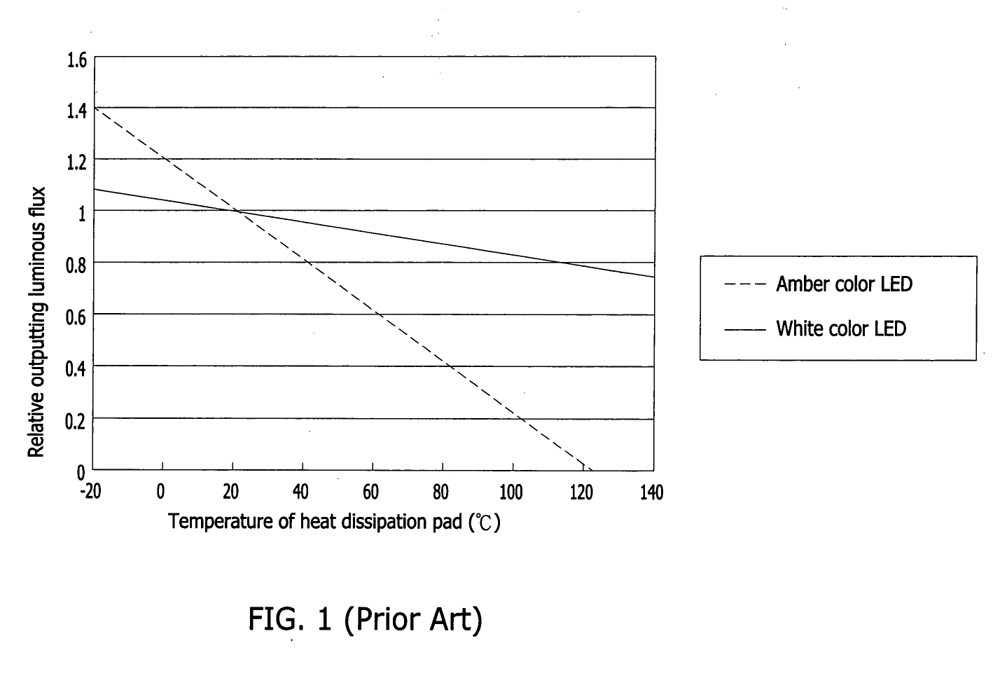

The first light emitting element 130 and the second light emitting element 140 are, for example, light emitting diodes (LEDs). The luminance of the first light emitting element 130 is easier to vary with a change of temperature than the luminance of the second light emitting element 140. In the embodiment, the emitted light color of the first light emitting element 130 is different from the emitted light color of the second light emitting element 140. Specifically, the first light emitting element 130 is for example the LED adapted for emitting an amber color light, and the second light emitting element 140 is for example the LED adapted for emitting a white color light. As shown in FIG. 1, the luminance of the first light emitting element 130 emitting the amber color light is easier to decrease than the luminance of the second light emitting element 140 emitting the white color light according to the increase of the working temperature (that is thermal fade).

In the embodiment, the first heat transfer element 110 and the second heat transfer element 120 are heat conductors. Besides, after working for a period of time, the working temperature of the first light emitting element 130 and the working temperature of the second light emitting element 140 rise. For improving the problem of the luminance of the first light emitting element 130 fading excessively, the thermal resistance of the first transfer element 110 may be designed smaller than the thermal resistance of the second transfer element 120. In other words, the heat dissipation efficiency of the first heat transfer element 110 is greater than the heat dissipation efficiency of the second heat transfer element 120, so as to effectively reduce the rising degree of the working temperature of the first light emitting element 130, and consequently, reduce the luminance fading degree of the first light emitting element 130. It is noticeable that the first heat transfer element 110 is not limited to be a heat conductor. In other embodiments, the first heat dissipation 110 may be a vapor chamber or a heat pipe.

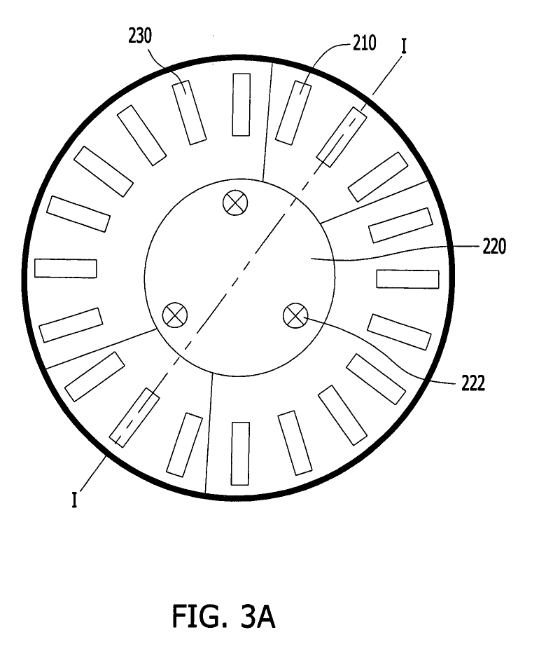

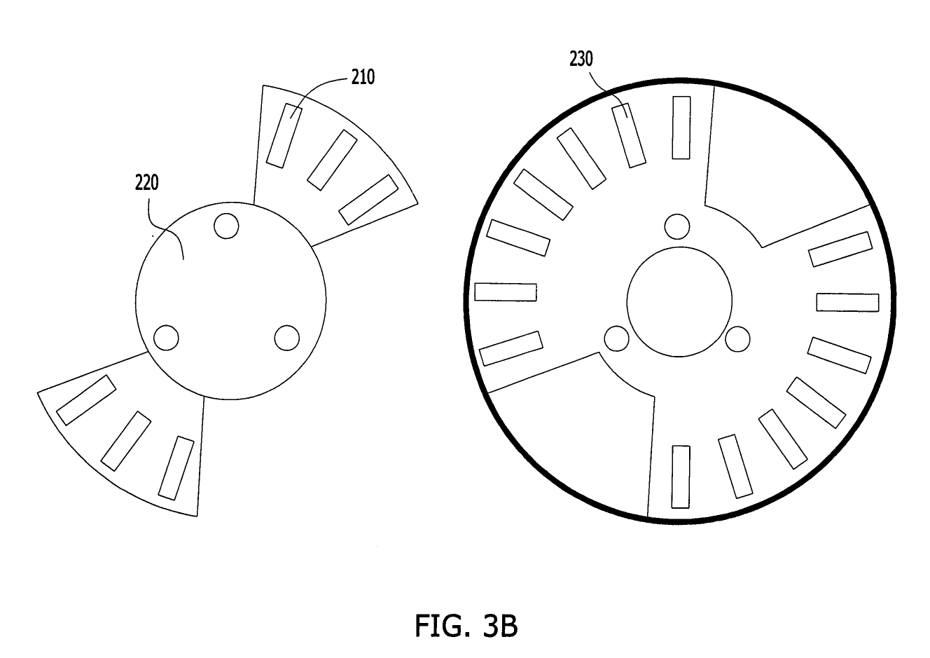

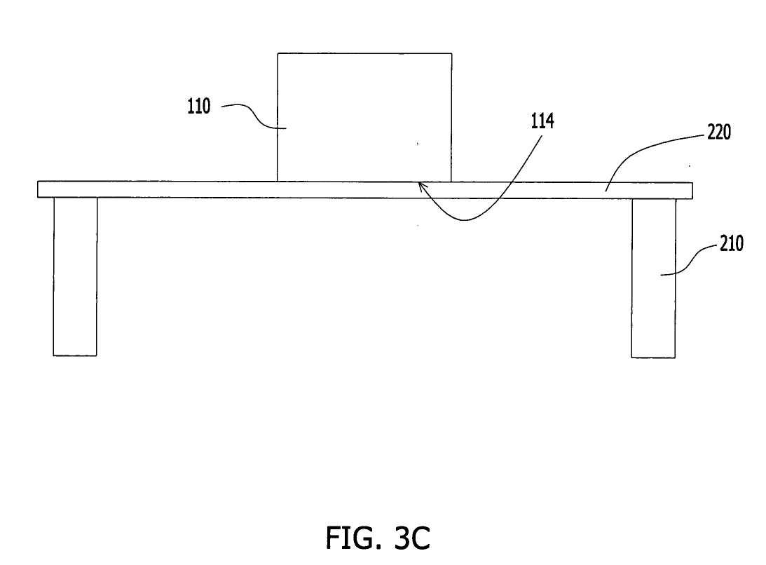

FIG. 3A is the bottom view showing the first heat dissipation fins, the second heat dissipation fins, and the connecting strip in FIG. 2A. FIG. 3B is the explosion view showing the first heat dissipation fins, the second heat dissipation fins, and the connecting strip in FIG. 3A. FIG. 3C is the I-I section view showing the first heat transfer element, the connecting strip, and the first heat dissipation fins in FIG. 3A. Please refer to FIG. 2A and FIGS. 3A-3C, in the embodiment, the light source apparatus 100 further includes a plurality of first heat dissipation fins 210, and the first heat dissipation fins 210 are connected to the first heat dissipation surface 114. Specifically, the first heat dissipation fins 210 are connected to the first heat dissipation surface 114 via a connecting strip 220, and the connecting strip 220 is fixed to the second heat dissipation surface 124. In the embodiment, the connecting strip 220 is fixed to the second heat dissipation surface 124 by a plurality of fixing elements 222 passing through the outer edge of the connecting strip 220 and the inner edge of the second heat dissipation surface 124.

In one embodiment of the invention, the light source apparatus 100 further includes a plurality of second heat dissipation fins 230, and the second heat dissipation fins 230 are connected to the second heat dissipation surface 124. In the embodiment, the first heat dissipation fins 210 and the second heat dissipation fins 230 are disposed below the second heat dissipation surface 124 and around the first heat dissipation surface 114. The first heat dissipation fins 210 and the second heat dissipation fins 230 are respectively conducive to conduct the heat of the first heat transfer element 110 and the second heat transfer element 120 to the air more quickly. Besides, in the embodiment, the quantity ratio of the first heat dissipation fins 210 to the second heat dissipation fins 230 may be changed according to the users' requirement. When the quantity ratio of the first heat dissipation fins 210 to the second heat dissipation fins 230 is bigger, the heat dissipation efficiency of the first light emitting element 130 is better. On the contray, when the quantity ratio of the first heat dissipation fins 210 to the second heat dissipation fins 230 is smaller, the heat dissipation efficiency of the second light emitting element 140 is better. In the embodiment, there is a gap G between the first heat transfer element 110 and the second heat transfer element 120. Therefore, the heat dissipation paths of the first light emitting element 130 and the second light emitting element 140 may not be disturbed by each other, so as to control the thermal fade of the luminance of the first light emitting element 130 more precisely. However, in other embodiments, the first heat transfer element 110 may also contact with the second heat transfer element 120, and the heat of the first heat transfer element 110 may be conducted to the second heat transfer element 120. Furthermore, in other embodiments, the light source apparatus 100 may not have the first heat dissipation fins 210, and the heat generated by the first light emitting element 130 may be transmitted to the first heat transfer element 110, the second heat transfer element 120, and the second heat dissipation fins 230 in sequence, and the heat may be conducted to the air.

In the embodiment, the light source apparatus 100 further includes a fan 240, the fan 240 is disposed below the first heat dissipation surface 114, and the first heat dissipation fins 210 and the second heat dissipation fins 230 are disposed around the fan 240. The fan 240 rotates and forms an air flow, and therefore, the heat of the first heat dissipation fins 210 and the second heat dissipation fins 230 may be conducted to the air more quickly.

It is noticeable that the first heat dissipation fins 210 and the second heat dissipation fins 230 are not limited to be disposed around the first heat dissipation surface 114 in the invention. In some embodiments, the first heat dissipation fins 210 and the second heat fins 230 may be disposed in other arrangements. For example, the first heat dissipation fins 210 and the second heat dissipation fins 230 may be disposed below the first heat dissipation surface 114 and the second heat dissipation surface 124 by being parallel to each other.

In the embodiment, the first heat transfer element 110 is capable of protruding from the second carrying surface 122 and has a side reflection surface 116 between the first carrying surface 112 and the second carrying surface 122. The side reflection surface 116 is adapted for reflecting the light emitted from the second light emitting element 140. A light beam 142 emitted from the second light emitting element 140 may be transmitted to outside more divergently via the reflection of the side reflection surface 116. Furthermore, in the embodiment, the thickness of the first heat transfer element 110 in the direction perpendicular to the first carrying surface 112 is greater than the thickness of the second heat transfer element 120 in the direction perpendicular to the second carrying surface 122. Therefore, the first heat transfer element 110 may have a larger heat dissipation volume, so as to further increase the heat dissipation efficiency of the first heat transfer element 110.

Please refer to FIG. 2A, in the embodiment, the light source apparatus 100 further includes a drive circuit 250, and the drive circuit 250 is electrically connected to the first light emitting element 130 and the second light emitting element 140 for driving the first light emitting element 130 and the second light emitting element 140 to emit light. Besides, in the embodiment, the light source apparatus 100 further includes a lamp base 260, and the lamp base 260 is electrically connected to the drive circuit 250. The lamp base 260 is adapted to be screwed into a general lamp socket to electrically connect to the city electricity. Moreover, the light source apparatus 100 further includes a lamp body 270, the lamp body 270 surrounds the first heat transfer element 110 and the second heat transfer element 120 to protect the inside elements, and the light source apparatus 100 may be with a better appearance. Besides, the light source apparatus 100 further includes a light transmissive cover 280, and the light transmissive cover 280 is disposed on the lamp body 270 and covers the first light emitting element 130 and the second light emitting element 140.

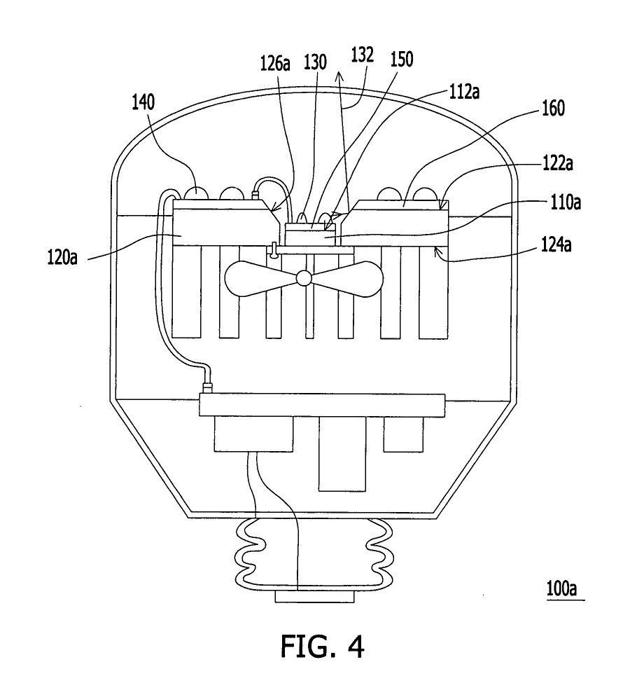

FIG. 4 is the section view showing another embodiment of the light source apparatus according to the present invention. Please refer to FIG. 4, the light source apparatus 110a according to the embodiment is similar to the light source apparatus 100 mentioned above (as shown in FIG. 2A), and the differences between the light source apparatus 100 and the light source apparatus 100a are described as following. In the light source apparatus 100a, the first carrying surface 112a of the first heat transfer element 110a is disposed between the second carrying surface 122a and the second heat dissipation surface 124a of the second heat transfer element 120a. Besides, the second heat transfer element 120a has an inner reflection surface 126a between the first carrying surface 112a and the second carrying surface 122a, the inner reflection surface 126a is adapted for reflecting the light beam 132 emitted from the first light emitting element 130, and thus the light mixing effect of the light beam 132 emitted from the first light emitting element 130 is enhanced. The inner reflection surface 126a may be inclined relatively to the second carrying surface 122a to further enhance the light mixing effect, and the inclination angle may be designed according to the users' demand.

As described above, according to the embodiment of the invention, since the thermal resistance of the first heat transfer element is smaller than the thermal resistance of the second heat transfer element, the first light emitting element having the luminance being easier to vary with the change of temperature may be disposed over the first heat transfer element, so as to reduce the rising degree of the working temperature of the first light emitting element, and consequently, reduce the luminance fading degree of the first light emitting element. Besides, the first heat transfer element may have the side reflection surface, so as to make the light source apparatus provide a divergent light source, or the second heat transfer element may have the inner reflection surface for enhancing the light mixing effect.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily_limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A light source apparatus, comprising:
a first heat transfer element, having a first carrying surface and a first heat dissipation surface opposite to the first carrying surface;
a second heat transfer element, surrounding the first heat transfer element and having a second carrying surface and a second heat dissipation surface opposite to the second carrying surface, wherein the thermal resistance of the first heat transfer element is smaller than the thermal resistance of the second heat transfer element;
at least one first light emitting element, disposed over the first carrying surface; and
at least one second light emitting element, disposed over the second carrying surface, wherein the luminance of the first light emitting element is easier to vary with a change of temperature than the luminance of the second light emitting element.

2. The light source apparatus of claim 1, wherein the first light emitting element and the second light emitting element comprise light emitting diodes.

3. The light source apparatus of claim 1, wherein the emitted light color of the first light emitting element is different from the emitted light color of the second light emitting element.

4. The light source apparatus of claim 1, wherein the first heat transfer element and the second heat transfer element comprise heat conductors.

5. The light source apparatus of claim 1, wherein the first heat transfer element comprises a vapor chamber or a heat pipe, and the second heat transfer element comprises a heat conductor.

6. The light source apparatus of claim 1, further comprising a plurality of second heat dissipation fins connecting to the second heat dissipation surface.

7. The light source apparatus of claim 6, further comprising a plurality of first heat dissipation fins connecting to the first heat dissipation surface.

8. The light source apparatus of claim 7, further comprising a connecting strip, wherein the first heat dissipation fins are connected to the first heat dissipation surface via the connecting strip, and the connecting strip is fixed to the second heat dissipation surface.

9. The light source apparatus of claim 8, wherein there is a gap between the first heat transfer element and the second heat transfer element.

10. The light source apparatus of claim 7, wherein the first heat dissipation fins and the second heat dissipation fins are disposed below the second heat dissipation surface and around the first heat dissipation surface.

11. The light source apparatus of claim 10, further comprising a fan disposed below the first heat dissipation surface, wherein the first heat dissipation fins and the second heat dissipation fins are disposed around the fan.

12. The light source apparatus of claim 1, wherein the first heat transfer element is capable of protruding from the second carrying surface, the first heat transfer element has a side reflection surface between the first carrying surface and the second carrying surface, and the side reflection surface is adapted for reflecting the light emitted from the second light emitting element.

13. The light source apparatus of claim 1, wherein the first carrying surface is disposed between the second carrying surface and the second heat dissipation surface, the second heat transfer element has an inner reflection surface between the first carrying surface and the second carrying surface, and the inner reflection surface is adapted for reflecting the light emitted from the first light emitting element.

14. The light source apparatus of claim 1, wherein the first heat dissipation surface and the second heat dissipation surface are substantially capable of facing the same direction.

15. The light source apparatus of claim 1, further comprising:
a first circuit board, disposed between the first carrying surface and the first light emitting element and electrically connected to the first light emitting element; and
a second circuit board, disposed between the second carrying surface and the second light emitting element and electrically connected to the second light emitting element and the first circuit board.

16. The light source apparatus of claim 15, further comprising:
a plurality of wires, wherein one end of each of the wires is electrically connected to the first light emitting element;
a first electrical connector, connected to another end of each of the wires; and
a second electrical connector, disposed on the second circuit board and electrically connected to the second circuit board, wherein the first electrical connector and the second electrical connector are adapted for being electrically connected by inosculating each other.

17. The light source apparatus of claim 1, further comprising a drive circuit and a lamp base, the drive circuit electrically connected to the first light emitting element and the second light emitting element, and the lamp base electrically connected to the drive circuit.

18. The light source apparatus of claim 1, further comprising a lamp body and a light transmissive cover, the lamp body surrounding the first heat transfer element and the second heat transfer element, and the light transmissive cover disposed on the lamp body and covering the first light emitting element and the second light emitting element.
